(19) United States
(12) Patent Application Publication
(10) Pub. No.: US 2025/0353416 A1
(43) Pub. Date: Nov. 20, 2025

(54) SEAT CUSHION

(71) Applicant: TOYOTA BOSHOKU KABUSHIKI KAISHA, Aichi-ken (JP)

(72) Inventors: Hiroaki TERAGUCHI, Miyoshi-shi (JP); Naoki NISHIMURA, Nagoya-shi (JP); Yoshiki MISHIMA, Chiryu-shi (JP); Kazuhito DANNO, Seto-shi (JP)

(73) Assignee: TOYOTA BOSHOKU KABUSHIKI KAISHA, Aichi-ken (JP)

(21) Appl. No.: 19/193,018

(22) Filed: Apr. 29, 2025

(30) Foreign Application Priority Data
May 14, 2024 (JP) 2024-078495

(51) Int. Cl. B60N 2/68; B60N 2/02

(52) U.S. Cl. CPC B60N 2/68; B60N 2/0284; B60N 2205/30

(57) ABSTRACT

There is provided a seat cushion including: a seat frame; and a cushion body divided into three elements that are a top plate main portion forming a central portion in a seat width direction, and top plate side portions each forming a side portion in the seat width direction. The seat frame includes a frame front portion supporting a main front portion from the seat back surface side, and a frame rear portion supporting a main rear portion and each of the top plate side portions from the seat back surface side. The seat cushion further includes: a cushion length variable mechanism configured to extend a cushion length of the top plate main portion; and a first protruding portion protruding from one of the frame front portion and the frame rear portion to the other to planarly cover a gap formed between the one and the other.

### CROSS-REFERENCE TO RELATED APPLICATIONS

This application is based on and claims priority under 35 USC 119 from Japanese Patent Application No. 2024-078495 filed on May 14, 2024, the contents of which are incorporated herein by reference.

### TECHNICAL FIELD

The present disclosure relates to a seat cushion. Specifically, the present disclosure relates to a seat cushion including a cushion body that elastically supports a seated person and a seat frame that supports the cushion body from a seat back surface side.

### BACKGROUND ART

JP2020-033005A discloses a divided seat in which a cushion body that elastically supports a seated person includes three divided elements, that is, a top plate main portion forming a central portion in a seat width direction and top plate side portions each forming a side portion in the seat width direction.

When a mechanism capable of adjusting a cushion length of the seat cushion is provided in the divided seat described in JP2020-033005A, for example, a configuration in which a front portion of the top plate main portion is moved toward a seat front side with respect to a rear portion can be considered. In this case, if the front portion of the top plate main portion protrudes further toward the seat front side than the top plate side portions, foreign objects may be bit therebetween from a side, which is not preferable. Therefore, the present disclosure provides a seat cushion capable of preventing the biting of foreign objects even if a cushion length variable mechanism is provided in a top plate main portion separated from a top plate side portion.

### SUMMARY OF INVENTION

In view of the above circumstances, a seat cushion according to the present disclosure is configured as follows.

According to a first aspect of the present disclosure, a seat cushion includes: a cushion body configured to elastically support a seated person; and a seat frame configured to support the cushion body from a seat back surface side. The cushion body includes three divided elements that are a top plate main portion forming a central portion in a seat width direction, and top plate side portions each forming a side portion in the seat width direction. The seat frame includes a frame front portion that supports a main front portion from the seat back surface side, and a frame rear portion that supports a main rear portion and each of the top plate side portions from the seat back surface side, the main front portion being a front portion of the top plate main portion, and the main rear portion being a rear portion of the top plate main portion. The seat cushion further includes: a cushion length variable mechanism configured to extend a cushion length of the top plate main portion by moving the frame front portion toward a seat front side with respect to the frame rear portion; and a first protruding portion that protrudes from one of the frame front portion and the frame rear portion to the other to planarly cover a gap formed between the one and the other from a side of the gap as the cushion length extends.

According to the first aspect of the present disclosure, the gap formed by the extension of the cushion length is planarly covered from a side by the first protruding portion protruding from the frame front portion or the frame rear portion. Therefore, even if the cushion length of the top plate main portion separated from the top plate side portion can be changed, it is possible to prevent the biting of foreign objects between the main front portion and the main rear portion from the side.

According to a second aspect of the present disclosure, in the seat cushion according to the first aspect, the top plate main portion includes a main pad that forms a seat pad and a main base member attached to a pad back surface of the main pad. The first protruding portion is provided on the frame rear portion to protrude toward the seat front side. The seat cushion further includes a second protruding portion provided on a base member front portion forming the main front portion of the main base member, the second protruding portion protruding toward a seat rear side to planarly cover the gap from the side of the gap together with the first protruding portion.

According to the second aspect of the present disclosure, both the first protruding portion that protrudes from the frame rear portion toward the seat front side and the second protruding portion that protrudes from the base member front portion toward the seat rear side can more appropriately prevent the biting of foreign objects between the main front portion and the main rear portion from the side.

According to a third aspect of the present disclosure, in the seat cushion according to the first or second aspect, the top plate main portion further includes a main cover that covers the main pad from a seat front surface side. The main cover includes a side cover portion that planarly covers a pad side surface of the main pad, the gap, and the first protruding portion from the side of the gap.

According to the third aspect, the side cover portion is supported from the cover back surface side by the first protruding portion. Therefore, thanks to “tension” caused when the side cover portion is brought into contact with the first protruding portion and is stretched, it is possible to prevent the biting of the foreign objects over a wide range in which the side cover portion is stretched.

According to a fourth aspect of the present disclosure, in the seat cushion according to the third aspect, the main cover includes a back surface member provided to overlap a cover back surface of the side cover portion.

According to the fourth aspect, the hardness of the side cover portion can be increased, and it is possible to more appropriately prevent the biting of the foreign objects via the side cover portion.

### BRIEF DESCRIPTION OF DRAWINGS

FIG. 1 is a perspective view illustrating a schematic configuration of a seat cushion according to a first embodiment;

FIG. 2 is an exploded perspective view of the seat cushion;

FIG. 3 is a perspective view illustrating a configuration of a cushion length variable mechanism;

FIG. 4 is a perspective view illustrating a state before a cushion length is extended;

FIG. 5 is a side view of FIG. 4;

FIG. 6 is a perspective view illustrating a state in which the cushion length is extended;

FIG. 7 is a rear view of FIG. 6;

FIG. 8 is a plan view of FIG. 7;

FIG. 9 is a perspective view illustrating a configuration of a main portion of a seat cushion according to a second embodiment; and

FIG. 10 is a perspective view illustrating a configuration of a main portion of a seat cushion according to a third embodiment.

### DESCRIPTION OF EMBODIMENTS

Hereinafter, embodiments according to the present disclosure will be described with reference to the drawings.

### First Embodiment

### (Schematic Configuration of Seat Cushion 1)

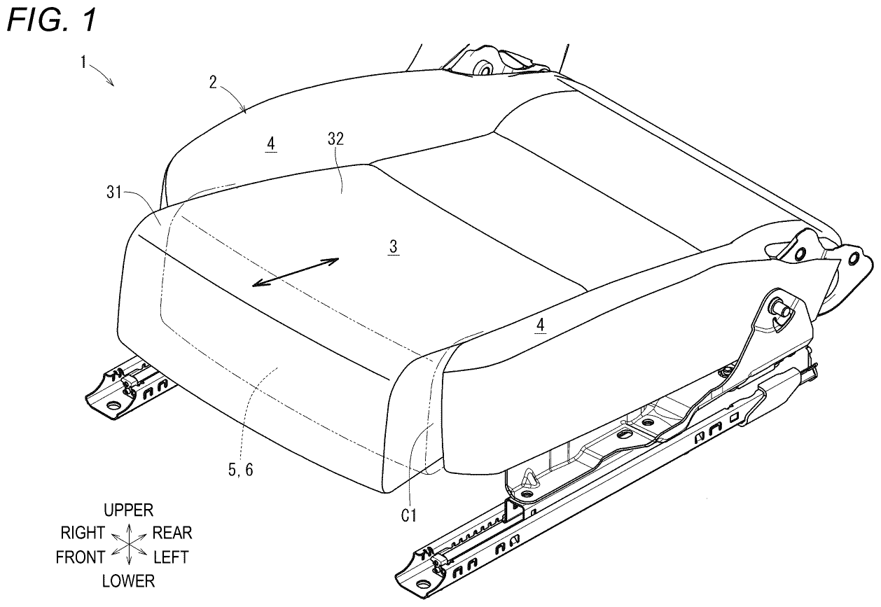

First, a configuration of a seat cushion 1 according to a first embodiment of the present disclosure will be described with reference to FIGS. 1 to 8. In the following description, when a direction such as front, rear, upper, lower, left, or right is described, it is assumed that the direction indicates a corresponding direction illustrated in the drawings.

When combinations of the directions with a word “seat” are described such as a “seat width direction”, the combinations indicate directions based on the seat cushion 1. In addition, in the following description, when a specific reference diagram is not illustrated or when there is no corresponding reference numeral in the reference diagram, any one of FIGS. 1 to 8 is referred to as appropriate.

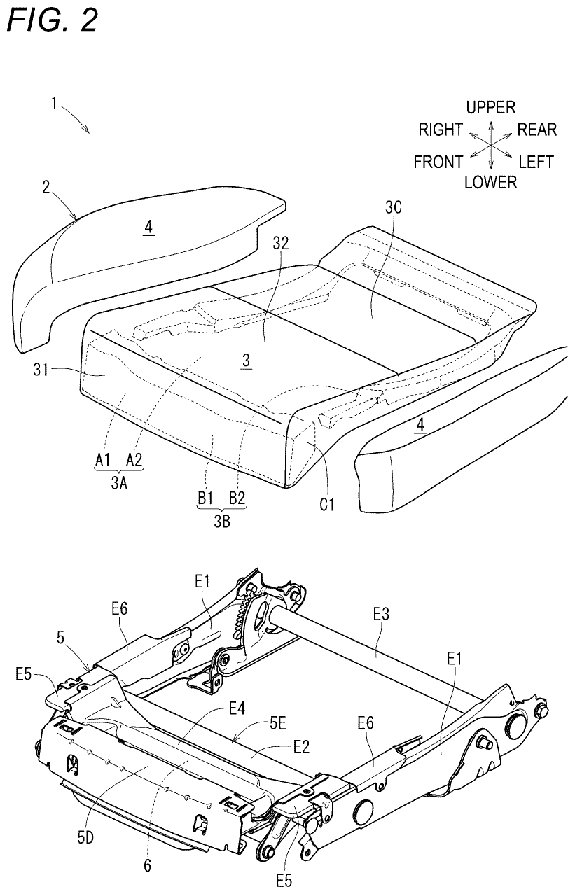

As illustrated in FIG. 1, the seat cushion 1 according to the present embodiment is implemented as a seating portion of an automobile seat. As illustrated in FIGS. 1 and 2, the seat cushion 1 includes a cushion body 2 that elastically supports buttocks and thighs of the seated person, and a metal cushion frame 5 that supports the cushion body 2 from a seat back surface side (lower side in FIGS. 1 and 2).

The cushion body 2 is configured to be divided into three divided elements, that is, a top plate main portion 3 forming a central portion in a seat width direction and top plate side portions 4 each forming a side portion in the seat width direction. Since the cushion body 2 is divided in this manner, each divided element can be replaced according to specifications thereof.

As illustrated in FIG. 2, the top plate main portions 3 and the top plate side portions 4 are individually assembled to the cushion frame 5 from a seat front surface side (upper side in FIG. 2). The top plate main portion 3 includes a main pad 3A made of urethane foam and a main base member 3B made of a resin and assembled so as to be brought into contact with the main pad 3A from a pad back surface side.

The top plate main portion 3 includes a main cover 3C made of fabric and covering the main pad 3A. The main cover 3C covers the main pad 3A from a pad front surface side (upper side in FIG. 2). A cover terminal of the main cover 3C, which is a peripheral portion on a rear side and left and right sides thereof, is pulled in toward a base member back surface side (lower side in FIG. 2) of the main base member 3B and fixed to a base member peripheral portion.

Accordingly, the main cover 3C is integrated with the main base member 3B to wrap the main pad 3A between the main cover 3C and the main base member 3B. As a result, the main base member 3B is fixed in a state of being in contact with the pad back surface of the main pad 3A via the main cover 3C.

The top plate main portion 3 is assembled to the cushion frame 5 in a state in which the main pad 3A, the main base member 3B, and the main cover 3C are assembled into one as described above. Specifically, the top plate main portion 3 is set such that the main base member 3B thereof is brought into contact with the cushion frame 5 from the seat front surface side, and is integrally fastened by a clip or a bolt (not illustrated).

Further, the top plate main portion 3 is fixed to the cushion frame 5 by pulling in and hooking the cover terminal on the front side of the main cover 3C toward the frame back surface side (lower side in FIG. 2) of the cushion frame 5.

The cushion frame 5 includes a frame front portion 5D that supports a main front portion 31, which is a front portion of the top plate main portion 3, from the seat back surface side, and a frame rear portion 5E that supports a main rear portion 32, which is a rear portion of the top plate main portion 3, and each top plate side portion 4 from the seat back surface side. Specifically, the frame rear portion 5E includes a pair of left and right lower arms E1 forming a framework along both left and right side portions of the seat cushion 1.

The frame rear portion 5E includes a front pipe E2 integrally bridged between front portions of the lower arms E1, and a rear pipe E3 integrally bridged between rear portions of the lower arms E1. Further, the frame rear portion 5E has a tilt panel E4 provided between the front portions of the lower arms E1 such that a panel surface of the tilt panel E4 faces in a seat height direction.

Tilt side panels E5 are connected to both left and right side portions of the tilt panel E4 so as to overlap upper portions of the lower arms E1. In the tilt panel E4, each tilt arm E6 extending from the left and right tilt side panels E5 to a seat rear side is connected to each lower arm E1 so as to be rotatable around an axis extending in the seat width direction.

Accordingly, the tilt panel E4 can adjust a seating surface angle with respect to each lower arm E1 by rotation around the axis extending in the seat width direction in accordance with driving of a drive unit (not illustrated) connected to each lower arm E1. The frame front portion 5D is provided on a front portion of the tilt panel E4.

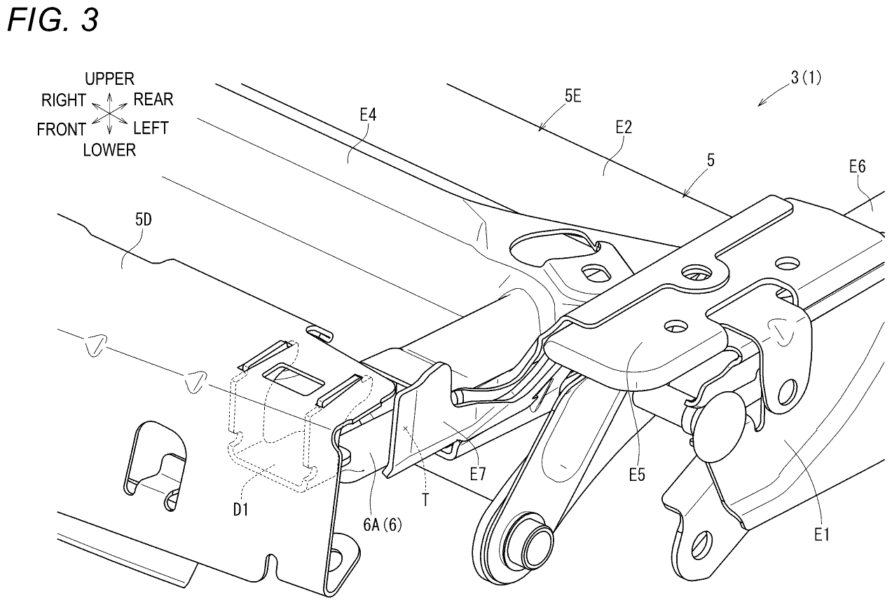

As illustrated in FIG. 3, the seat cushion 1 further includes a cushion length variable mechanism 6 configured to extend a cushion length by moving the frame front portion 5D toward a seat front side with respect to the tilt panel E4. The cushion length variable mechanism 6 includes a pair of left and right sliding pipes 6A connected to a bottom portion of the tilt panel E4 so as to be slidable in a seat front-rear direction.

Each sliding pipe 6A is formed of a round pipe material extending straight in the seat front-rear direction. A front end portion of each sliding pipe 6A is welded to a bottom portion of each support bracket D1 that is welded to the back surface of a top plate of the frame front portion 5D and is bent in a U shape in a front view. Each of the support brackets D1 is disposed so as to be positioned further inward in the seat width direction than each first protruding portion E7 to be described that protrudes from each of the tilt side panels E5 toward the seat front side.

Each sliding pipe 6A is configured to be moved in the seat front-rear direction with respect to the tilt panel E4 in accordance with driving of the drive unit (not illustrated) connected to the bottom portion of the tilt panel E4. Accordingly, the position of the frame front portion 5D in the seat front-rear direction with respect to the tilt panel E4 is adjusted.

When the frame front portion 5D is pulled out from the tilt panel E4 toward the seat front side, the main front portion 31 (see FIG. 2) provided on an upper portion of the frame front portion 5D is pulled out from the main rear portion 32 located on an upper portion of the tilt panel E4 toward the seat front side. As a result, the cushion length of the top plate main portion 3 is extended.

Referring to FIG. 2, the main pad 3A constituting the top plate main portion 3 is divided into two portions, that is, a pad front portion A1 installed on an upper portion of the frame front portion 5D and a pad rear portion A2 installed on an upper portion of the frame rear portion 5E. The main base member 3B is also divided into two portions, that is, a base member front portion B1 that is in contact with a pad back surface of the pad front portion A1 and a base member rear portion B2 that is in contact with a pad back surface of the pad rear portion A2. The base member front portion B1 is fixed to the upper portion of the frame front portion 5D. Further, the base member rear portion B2 is fixed to the upper portion of the frame rear portion 5E.

The main cover 3C covers the pad front portion A1 and the pad rear portion A2 so as to straddle them from the pad front surface side (upper side in FIG. 2). In a state before the cushion length is extended, a portion of the main cover 3C that covers a place between the pad front portion A1 and the pad rear portion A2 is pulled in toward a seat lower side from the place therebetween and is held.

As the pad front portion A1 moves to be pulled out toward the seat front side, the main cover 3C is pulled out such that a portion of the main cover 3C pulled in between the pad front portion A1 and the pad rear portion A2 is stretched therebetween. As a result, the main cover 3C is stretched between the pad front portion A1 pulled out toward the seat front side and the pad rear portion A2. Further, the main cover 3C is configured to be pulled in between the pad front portion A1 and the pad rear portion A2 again as the pad front portion A1 returns to the seat rear side.

As illustrated in FIG. 3, each of the tilt side panels E5 connected to both the left and right side portions of the tilt panel E4 described above is formed with a standing plate-shaped first protruding portion E7 that protrudes toward the seat front side. The first protruding portions E7 are formed to be bilaterally symmetrical to each other. Each of the first protruding portions E7 protrudes toward the seat front side from the tilt panel E4 and has an upright plate shape with a panel surface thereof facing in the seat width direction.

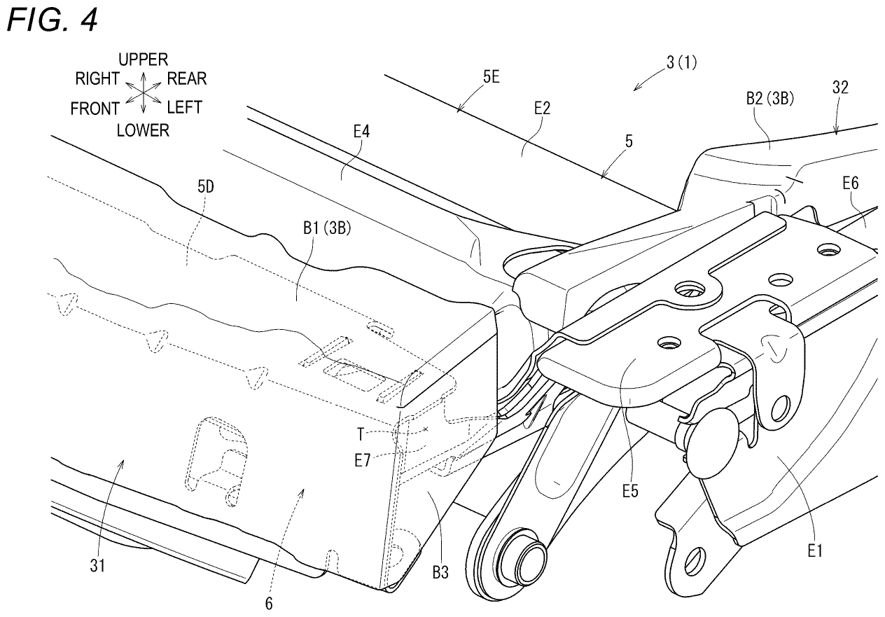

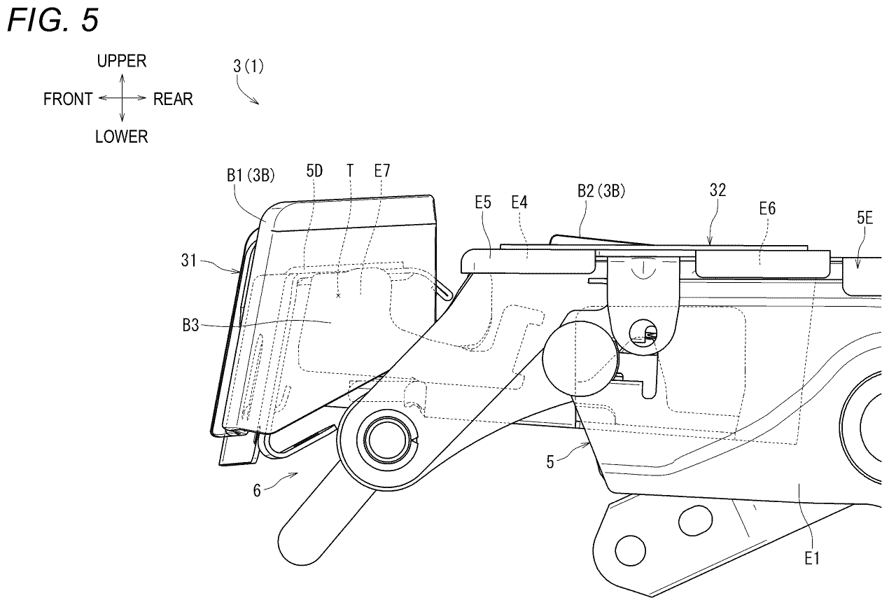

Each of the first protruding portions E7 is provided on a position lower than a top plate of the frame front portion 5D having an inverted L shape in a side view and higher than a lower edge of the frame front portion 5D. As illustrated in FIGS. 4 and 5, each of the first protruding portions E7 protrudes directly below the top plate of the frame front portion 5D in a state before the cushion length is extended.

In this state, each of the first protruding portions E7 is disposed to enter the inside of each of second protruding portions B3, which are left and right protruding surfaces of the base member front portion B1 and are assembled to the frame front portion 5D. The base member front portion B1 has an inverted L-shaped plate shape that covers the top plate and the front plate of the frame front portion 5D, and includes, on left and right side edges thereof, the second protruding portions B3 that protrude to planarly cover internal angle portions of an inverted L shape from both sides.

Each of the second protruding portions B3 has a standing plate shape that protrudes toward the seat rear side from left and right side edges of the front plate of the frame front portion 5D. Specifically, each of the second protruding portions B3 has an upright plate shape with a panel surface thereof facing in the seat width direction. Each of the second protruding portions B3 protrudes toward the seat rear side to substantially the same position as the rear edge of the top plate of the frame front portion 5D.

In a state before the cushion length is extended, each of the second protruding portions B3 is set in a state of overlapping with each of the first protruding portions E7 in the seat front-rear direction. Specifically, each second protruding portion B3 is set in a state of planarly covering the corresponding first protruding portion E7 from the outside in the seat width direction.

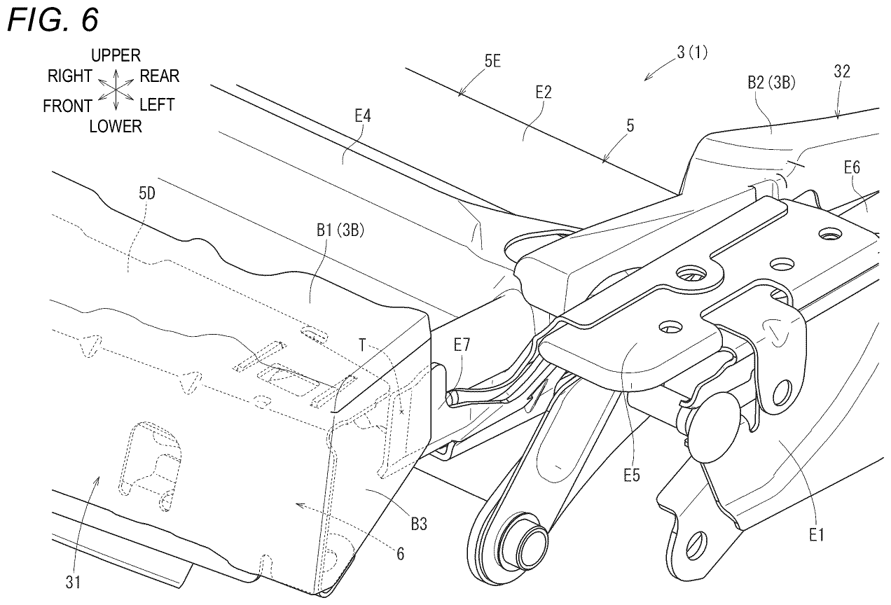

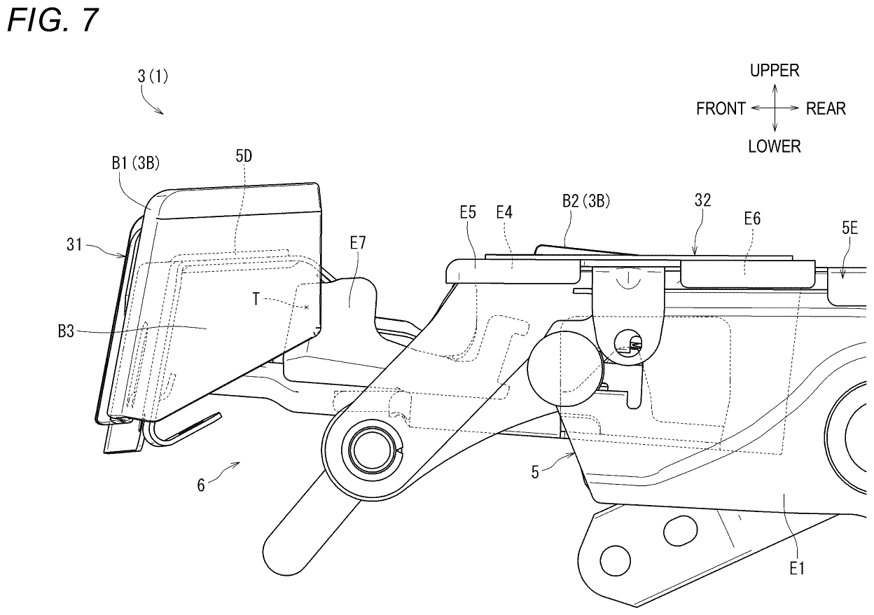

As illustrated in FIGS. 6 and 7, as the cushion length is extended forward, each of the first protruding portions E7 is gradually separated toward the seat rear side from each of the second protruding portions B3 moving toward the seat front side. Accordingly, each of the first protruding portions E7 planarly covers a gap T formed between each of the tilt side panels E5 and (each of the second protruding portions B3 of the base member front portion B1 assembled to) the frame front portion 5D from the side of the gap.

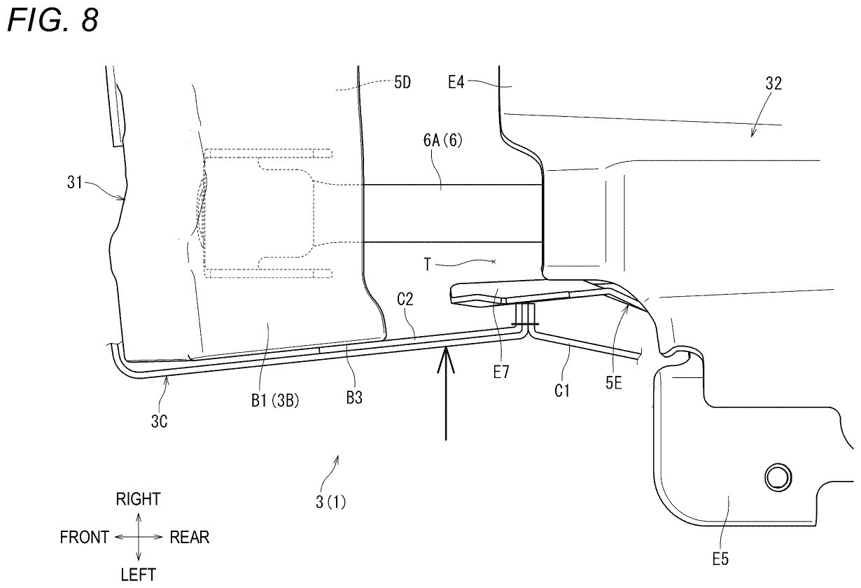

As a result, since the first protruding portions E7 and the second protruding portions B3 provides coverage from the sides, it is possible to prevent foreign objects from entering between the main front portion 31 and the main rear portion 32 from the sides. As illustrated in FIG. 8, in detail, each of the first protruding portions E7 and each of the second protruding portions B3 are configured such that each side cover portions C1 of the main cover 3C covers an outer side thereof.

The side cover portion C1 is a portion that covers each side surface of the pad front portion A1 and each side surface of the pad rear portion A2 of the main pad 3A illustrated in FIG. 2 from the side. Accordingly, even when a load is applied from the outside to each side cover portion C1, such as the pressing of foreign objects against the side cover portion C1, each side cover portion C1 is supported from the cover back surface side (the inside in the seat width direction) by each first protruding portion E7 and each second protruding portion B3.

As a result, the foreign objects are prevented from entering between the main front portion 31 and the main rear portion 32 from the side. Planar back surface members C2 made of the same material as each of the side cover portions C1 are integrally stacked on cover back surfaces of the side cover portions C1.

Accordingly, the side cover portion C1 is reinforced by the back surface member C2, so that surface rigidity (hardness) is appropriately increased. As a result, even when a load is applied from the outside to a portion of the side cover portion C1 that covers the gap T formed between the first protruding portion E7 and the second protruding portion B3, the side cover portion C1 is less likely to bend so as to enter between the first protruding portions E7 and the second protruding portions B3 thanks to “tension” caused when the side cover portion C1 is brought into contact with the first protruding portions E7 and the second protruding portions B3 and is stretched.

Each back surface member C2 may be made of a cloth material such as felt or nonwoven fabric different from that of each side cover portion C1. Further, each back surface member C2 may be formed of a resin plate.

To summarize the above, the seat cushion 1 according to the present embodiment may have the following configuration. In the following description, reference numerals assigned in parentheses correspond to the configurations described in the embodiment described above.

That is, the seat cushion (1) includes the cushion body (2) that elastically supports the seated person, and the seat frame (5) that supports the cushion body (2) from the seat back surface side. The cushion body (2) includes three divided elements that are the top plate main portion (3) forming a central portion in the seat width direction and the top plate side portions (4) each forming the side portion in the seat width direction. The seat frame (5) includes the frame front portion (5D) that supports the main front portion (31), which is the front portion of the top plate main portion (3), from the seat back surface side, and the frame rear portion (5E) that supports the main rear portion (32), which is the rear portion of the top plate main portion (3), and each top plate side portion (4) from the seat back surface side.

The seat cushion (1) further includes the cushion length variable mechanism (6) configured to extend the cushion length of the top plate main portion (3) by moving the frame front portion (5D) toward the seat front side with respect to the frame rear portion (5E). The seat cushion (1) further includes the first protruding portion (E7) that protrudes from one (5E) of the frame front portion (5D) and the frame rear portion (5E) toward the other (5D) and planarly covers the gap (T) formed between the one (5E) and the other (5D) from the side of the gap as the cushion length extends.

According to the above configuration, the gap (T) formed by the extension of the cushion length is covered in the planar manner from the side by the first protruding portion (E7) protruding from the frame front portion (5D) or the frame rear portion (5E). Therefore, even if the cushion length of the top plate main portion (3) separated from the top plate side portion (4) can be changed, it is possible to prevent the biting of the foreign objects between the main front portion (31) and the main rear portion (32) from the side.

The top plate main portion (3) includes the main pad (3A) forming the seat pad and the main base member (3B) attached to the pad back surface of the main pad (3A). The first protruding portion (E7) is provided on the frame rear portion (5E) to protrude toward the seat front side. The second protruding portion (B3) is provided on the base member front portion (B1) forming the main front portion (31) of the main base member (3B), the second protruding portion (B3) protruding toward the seat rear side to planarly cover the gap (T) from the side of the gap together with the first protruding portion (E7).

According to the above configuration, both the first protruding portion (E7) that protrudes from the frame rear portion (5E) toward the seat front side and the second protruding portion (B3) that protrudes from the base member front portion (B1) toward the seat rear side can more appropriately prevent the biting of the foreign objects between the main front portion (31) and the main rear portion (32) from the side.

The top plate main portion (3) further includes the main pad (3A) forming the seat pad and the main cover (3C) that covers the main pad (3A) from the seat front surface side. The main cover (3C) includes the side cover portion (C1) that planarly covers a pad side surface of the main pad (3A), the gap (T), and the first protruding portion (E7) from the side of the gap.

According to the above configuration, the side cover portion (C1) is supported from the cover back surface side by the first protruding portion (E7). Therefore, thanks to the “tension” caused when the side cover portion (C1) is brought into contact with the first protruding portion (E7) and is stretched, it is possible to prevent the biting of the foreign objects over a wide range in which the side cover portion (C1) is stretched.

Further, the main cover (3C) includes the back surface member (C2) provided to overlap the cover back surface of the side cover portion (C1). According to the above configuration, the hardness of the side cover portion (C1) can be increased, and it is possible to more appropriately prevent the biting of the foreign objects via the side cover portion (C1).

### Second Embodiment

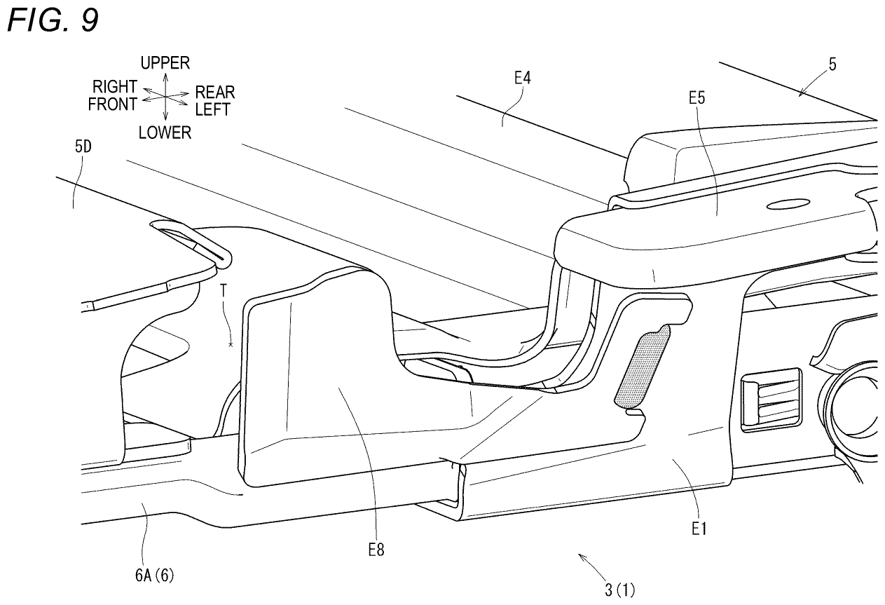

Next, a configuration of the seat cushion 1 according to a second embodiment of the present disclosure will be described with reference to FIG. 9. In the seat cushion 1 according to the present embodiment, each first protruding portion E8 that covers the gap T formed between each tilt side panel E5 and (each second protruding portion B3 of the base member front portion B1 assembled to) the frame front portion 5D from the side when the cushion length is extended is configured as follows.

That is, the first protruding portion E8 is formed of a member different from the tilt side panel E5. The first protruding portion E8 is integrally connected to the tilt side panel E5 by welding. Accordingly, the first protruding portions E8 is provided in a state of protruding from the tilt side panel E5 toward the seat front side, similarly to the first protruding portion E7 (see FIG. 3) described in the first embodiment. Since configurations other than the above are the same as the configuration disclosed in the first embodiment, the same reference numerals are given and the description thereof is omitted.

### Third Embodiment

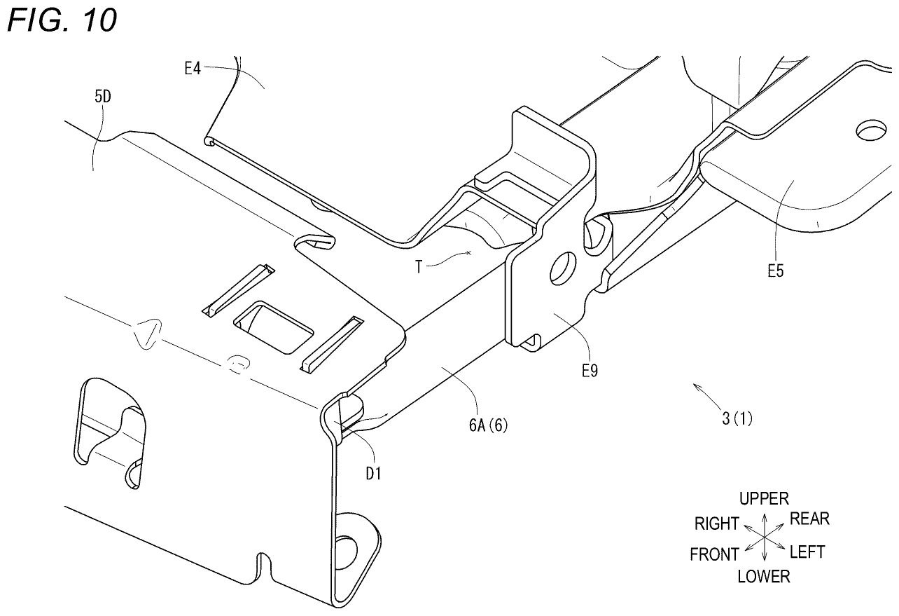

Next, a configuration of the seat cushion 1 according to a third embodiment of the present disclosure will be described with reference to FIG. 10. In the seat cushion 1 according to the present embodiment, each first protruding portion E9 that covers the gap T formed between each tilt side panel E5 and (each second protruding portion B3 of the base member front portion B1 assembled to) the frame front portion 5D from the side when the cushion length is extended is configured as follows.

That is, the first protruding portion E9 is formed of a member different from the tilt side panel E5. Each first protruding portion E9 is integrally connected to each side edge portion of the tilt panel E4 by welding. Accordingly, the first protruding portions E9 is provided in a state of protruding from the tilt side panel E5 toward the seat front side, similarly to the first protruding portion E7 (see FIG. 3) described in the first embodiment. Since configurations other than the above are the same as the configuration disclosed in the first embodiment, the same reference numerals are given and the description thereof is omitted.

### Other Embodiments

The embodiments according to the present disclosure have been described with reference to three embodiments, but the present disclosure can be implemented in various forms other than the above embodiments.

1. The seat cushion according to the present disclosure is applicable not only to a seat to be mounted on a vehicle such as an automobile or a railroad vehicle, but also to a seat to be mounted on other vehicles such as an aircraft or a ship. The seat cushion is also applicable to a seat not to be mounted on the vehicle.

2. The first protruding portion may protrude from both sides of one of the frame front portion and the frame rear portion of the seat frame, or may protrude from only one side. The first protruding portion may protrude from the frame rear portion toward the seat front side, or may protrude from the frame front portion toward the seat rear side. The first protruding portion may be integrally fixed to the one of the frame front portion and the frame rear portion by bolt fastening.

3. The main base member may be made of metal other than a resin.

What is claimed is:

1. A seat cushion comprising:
a cushion body configured to elastically support a seated person; and
a seat frame configured to support the cushion body from a seat back surface side, wherein
the cushion body includes three divided elements that are a top plate main portion forming a central portion in a seat width direction, and top plate side portions each forming a side portion in the seat width direction,
the seat frame includes a frame front portion that supports a main front portion from the seat back surface side, and a frame rear portion that supports a main rear portion and each of the top plate side portions from the seat back surface side, the main front portion being a front portion of the top plate main portion, and the main rear portion being a rear portion of the top plate main portion, and
the seat cushion further includes:
a cushion length variable mechanism configured to extend a cushion length of the top plate main portion by moving the frame front portion toward a seat front side with respect to the frame rear portion; and
a first protruding portion that protrudes from one of the frame front portion and the frame rear portion to the other to planarly cover a gap formed between the one and the other from a side of the gap as the cushion length extends.

2. The seat cushion according to claim 1, wherein
the top plate main portion includes a main pad that forms a seat pad and a main base member attached to a pad back surface of the main pad,
the first protruding portion is provided on the frame rear portion to protrude toward the seat front side, and
the seat cushion further includes a second protruding portion provided on a base member front portion forming the main front portion of the main base member, the second protruding portion protruding toward a seat rear side to planarly cover the gap from the side of the gap together with the first protruding portion.

3. The seat cushion according to claim 1, wherein
the top plate main portion further includes a main cover that covers the main pad from a seat front surface side, and
the main cover includes a side cover portion that planarly covers a pad side surface of the main pad, the gap, and the first protruding portion from the side of the gap.

4. The seat cushion according to claim 3, wherein
the main cover includes a back surface member provided to overlap a cover back surface of the side cover portion.
